(19) United States
(12) Patent Application Publication
(10) Pub. No.: US 2008/0036106 A1
(43) Pub. Date: Feb. 14, 2008

(54) Method for making a concrete structure

(76) Inventor: Randall L. Warnick, Smock, PA (US)

Correspondence Address: BUCHANAN INGERSOLL & ROONEY PC, P.O. BOX 1404, ALEXANDRIA, VA, 22313-1404, US

(21) Appl. No.: 11/500,593

(22) Filed: Aug. 8, 2006

(51) Int. Cl. E04B 1/16; B28B 3/00; B28B 7/36

(52) U.S. Cl. 264/31; 264/333; 264/338

(57) ABSTRACT

In a method for forming concrete structures a form having at least one elongate body has an L-shaped strip attached along the lower edge of the elongate body. The L-shaped strip has an inside corner radius. Concrete is then poured into the form and against the inside corner radius of the L-shaped strip. After the concrete has set, the form and L-shaped strip are removed from the concrete, which is partially cured, to provide a concrete body having a curved edge that corresponds to the L-shaped strip. Thereafter, the curved edge is finished with a hand tool to provide a smooth drip edge. Once the finishing is completed, the concrete is allowed to fully cure.

### BACKGROUND OF THE INVENTION

1. Field of the Invention

The present invention relates to a method for creating concrete structures, such as a patio, in a desired location by pouring concrete into a form and then removing the form.

2. Description of the Prior Art

The general practice for making a concrete structure involves pouring wet concrete into a form that defines a structure's shape. Once the concrete is fully cured, the form is removed from the concrete structure.

However, when making concrete structures that are cast-in-place, such as patios, it is typically necessary to hand finish portions of the concrete structure before it has fully cured. The standard practice for making such structures involves the pouring of concrete into a form, removing the form once the concrete has set, finishing the concrete with hand tools, and, thereafter, allowing the concrete to fully cure. Importantly, once the concrete has fully cured, it cannot be finished by using hand tools.

In making concrete patios, for example, finishing is undertaken to curve the patio's bottom edge. This curved bottom edge is commonly referred to as a drip edge. In making a drip edge, the standard practice involves the use of hand tools to scrape the patio's bottom edge into a desired smooth, curved edge.

The current practice of finishing cast-in-place concrete structures, such as patios, is extremely time consuming. Specifically, finishing is made difficult by the hardness and toughness qualities of the concrete. Thus, a method of making such concrete structures that reduces the time and effort involved in finishing the concrete structure is greatly needed.

The prior art discloses the use of forms for purposes of forming concrete structures. Examples of such uses are disclosed in U.S. Pat. App. Pub. Nos. 2005/0205753 and 2004/0079035. The prior art also discloses the use of spacer strips having an L-shaped side which are placed within a form before pouring concrete and which remain in place after the concrete has fully cured. Examples of such spacers are disclosed in U.S. Pat. Nos. 5,694,723 and 5,771,643.

In U.S. Pat. No. 5,694,723, Parker teaches the use of an L-shaped strip having a projection, or spacer, that creates a gap between a wall and the L-shaped strip. This gap aids in the drainage or removal of water or radon. Parker's L-shaped strip prevents a poured casting material (e.g. concrete) from entering into the gap defined by the L-shaped strip's projection. However, after the casting material is cured, the L-shaped strip is not removed from the concrete body. Consequently, Parker's spacer is not applied to concrete body edges that require further finishing. Instead, Parker's L-shaped strip remains a part of the created structure and acts as part of the structure's outer boundary. Thus, Parker's disclosed use of L-shaped strips does not solve the above mentioned problems associated with the finishing of concrete structures.

Takagi, in U.S. Pat. App. Pub. No. 2004/0079035, teaches the use of a precast construction form insert for use in the construction of structures made from casting material, e.g. concrete. The said insert diverts a portion of a poured casting material (e.g. concrete) such that the material will not enter certain portions of a form. Thus, once the casting material is cured, the structure contains openings for doorways, windows, or other devices. However, Takagi's insert requires the casting material (e.g. concrete) to be completely cured before the form and insert are removed.

Because the concrete is fully cured before the form and insert are removed, the problems associated with the finishing of concrete structures are not addressed by Takagi. Specifically, Takagi's insert is used in precast construction and is not used for cast-in-place construction. Moreover, the fully cured concrete is extremely hard and tough and is not capable of being finished with hand tools. Thus, U.S. Pat. App. Pub. No. 2004/0079035 does not solve the problems associated with finishing concrete structures that are cast-in-place, such as concrete patios, ramps, loading docks, or steps.

Takagi, in U.S. Pat. App. Pub. No. 2005/0205754, teaches the use of construction panels for use in the construction of structures made from casting material, e.g. concrete. Takagi discloses forms that require a casting material to be poured into the form and allowed to fully cure prior to removal of the form. In so doing, Takagi's forms can define a drip edge that creates drainage features in the cured material. However, the forms taught by Takagi require the casting material to be fully cured prior to the form being removed. Because the casting material must be fully cured prior to the form's removal, the cured material is not capable of being finished. Indeed, Takagi says nothing about finishing the cast form. Thus, U.S. Pat. App. Pub. No. 2005/0205754 does not even recognize the problems associated with finishing concrete structures.

Consequently, there is still a need for a method and form that enables the finishing of concrete to be achieved quickly and easily with hand tools. Such a method and/or form must permit concrete finishing to occur after the concrete has set, but before the concrete has fully cured.

### SUMMARY OF THE INVENTION

I provide a method of making concrete structures that permits finishing to occur after the poured concrete has set, but before it has fully cured. I provide a form having an outer boundary defined by at least one elongate body. An L-shaped strip having an inside corner radius is then attached adjacent to the lower edge of the elongate body. Concrete is then poured into the form and against the inside radius corner of the L-shaped strip. After the concrete has set, the form and L-shaped strip are removed from the concrete, which is only partially cured, to provide a concrete body that has a curved edge corresponding to the L-shaped strip. Once the L-shaped strip and form are removed, the partially cured concrete is finished by using hand tools. When the finishing is completed, the concrete is allowed to fully cure.

Other details, objects, and advantages of the invention will become apparent as the following description of certain present preferred methods of practicing the invention proceeds.

### BRIEF DESCRIPTION OF THE DRAWINGS

In the accompanying drawings, I have shown a present preferred embodiment of my invention and have illustrated certain present preferred methods of practicing my invention in which:

FIG. 1 is a perspective view of a patio.

FIG. 2 is a fragmentary view of a portion of a patio being formed in accordance with the present invention.

FIG. 3 is a perspective view of a portion of a form used in my method.

FIG. 4 is a perspective view of a portion of an L-shaped strip having an inside corner radius used in my method.

FIG. 5 is a perspective view of the form shown in FIG. 3, illustrating a presently preferred placement of a screw used to connect the L-shaped strip to the elongate body.

### DESCRIPTION OF THE PREFERRED EMBODIMENTS

A preferred concrete structure, a patio 1, is illustrated in FIG. 1. The patio 1 is typically a rectangular solid that is created by pouring concrete 3 into a form. Often the patio will be supported on a concrete block footer 7, but such footers are not always used. It is common practice to provide a smooth, curved edge 9 along the bottom of the patio 1. This smooth, curved edge 9 is called a drip edge.

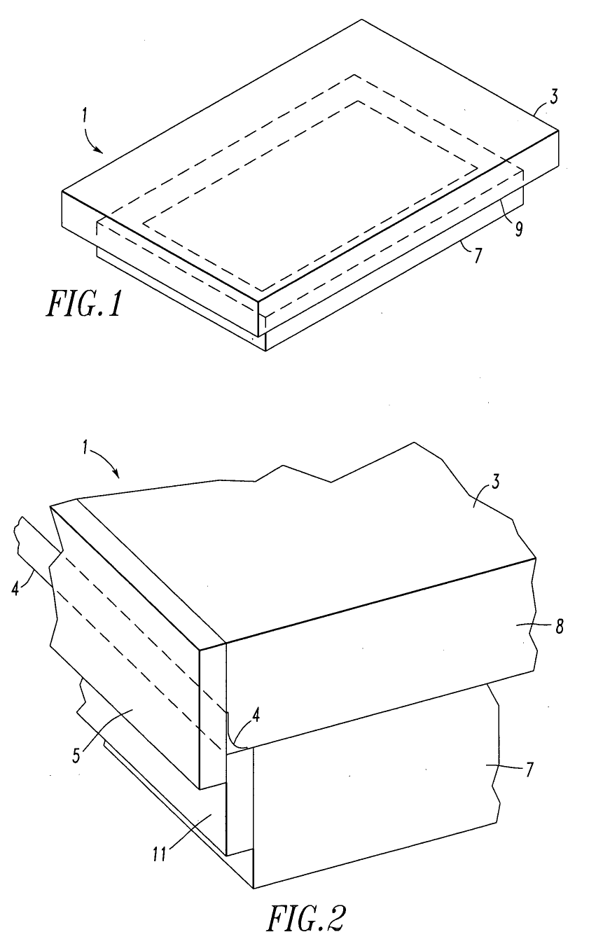

I provide a form that is comprised of at least one elongate body 8 positioned to define the shape of a patio 1. Elongate bodies 8 are typically made of wood, but can be made of other materials as well. In FIG. 2, the form is a 2″×6″ board 5 attached to a 2″×4″ board 11 that has been nailed to the footer 7. Before the concrete 3 is poured into the form, an L-shaped strip 4 is attached to at least one of the elongate bodies 8. An example of such an attachment is illustrated in FIG. 2, which shows that an L-shaped strip 4 is attached to a 2″×6″ board 5.

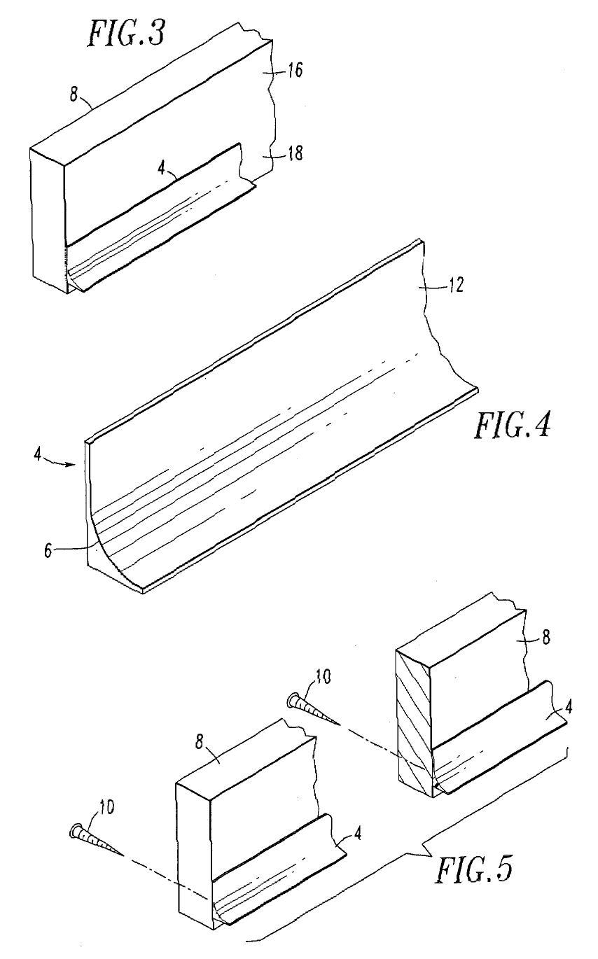

As shown in FIGS. 3, 4, and 5, the L-shaped strip 4 has an inside corner radius 6 and is attached adjacent to the lower edge 18 of the elongate body 8. The L-shaped strip 4 has an upper portion 12. Preferably the upper portion 12 is one inch high and the inside corner radius is ⅜″. The radius could be smaller or larger, preferably between ¼″ and ½″. The L-shaped strip is preferably made of a plastic material such as polycarbonate or polyvinyl chloride.

I prefer to use screws 10 to attach the L-shaped strip 4 to the form by connecting the lower edge 18 of the elongate body 8 to the upper portion 12 of the L-shaped strip 4, as can be seen in FIG. 5. I prefer to use a 1¾ inch drywall screw when attaching the L-shaped strip 4 to the lower edge 18 of the elongate body 8. However, other types of screws or other attachment devices may be used as well.

After the L-shaped strip 4 is attached to the elongate body 8, concrete is poured into the form and against the inside corner radius 6 of the L-shaped strip 4. The end of the screw may pass through the L-shaped strip and extend into the concrete. Because the screws are in the upper portion of the L-shaped strip, any screw ends that extend into the concrete will not affect the curved drip edge. Prior to pouring the concrete, however, I prefer to coat the L-shaped strip 4 with a lubricant to reduce any bonding that may take place between the L-shaped strip 4 and the concrete. This lubricant coating makes removing the L-shaped strip from the partially cured concrete easier. When coating the L-shaped strip with a lubricant, I prefer using 3-in-1 oil, sweet oil, or form oil.

Once the concrete 3 has set, but before it has fully cured, the form and L-shaped strip 4 are removed from the concrete 3 to provide the concrete body with a curved edge corresponding to the L-shaped strip 4.

When removing the L-shaped strip 4, I prefer to slide the L-shaped strip 4 longitudinally as indicated by the arrow in FIG. 2. I can thereby prevent the redistribution of concrete and resulting holes or depressions that can sometimes occur when the L-shaped strip 4 is removed by using other methods, such as pulling the L-shaped strip 4 away from the partially cured concrete.

Thereafter, the curved edge is finished to provide a smooth, curved edge 9. Because the curved edge of the concrete body requires significantly less material to be removed during finishing than concrete bodies made following the standard practice, my method permits finishing to be completed with hand tools in approximately seventy-five percent (75%) less time than it takes when using the standard practice. Once the finishing is completed, the concrete 3 is allowed to fully cure.

The concrete poured into the form may be any type of concrete used for forming concrete structures. Typically, concrete is a composite building material made from the combination of aggregate and binder. For example, concrete can consist of sand, conglomerate gravel, pebbles, broken stone, or slag in a mortar or cement binder. Of course, concrete may also be mixed with other types of binders, aggregates and/or additives not previously mentioned which are used to affect the concrete's properties, such as strength, curing time, or color.

While FIG. 2. illustrates a portion of a patio form, forms of various other concrete structures can be used in practicing my invention. For example, forms defining a ramp, a loading dock, or one or more steps may also be used.

It is common practice for other objects to be placed inside the boundaries of a form to be surrounded by concrete and improve various properties or characteristics of the concrete structure, such as strength or toughness. For example, steel rebar or steel mesh are often positioned inside the form before concrete is poured into the form. Of course, other objects may also be placed inside a form to improve various properties or characteristics of the structure. When such objects are used inside a form, however, they are incorporated into the concrete structure and are not subsequently removed. All of these things can be done before the concrete is poured into the form shown in the drawings.

While I have shown and described certain presently preferred methods of practicing my invention, it is to be distinctly understood that the invention is not limited thereto, but may be otherwise variously embodied and practiced within the scope of the following claims.

I claim:

1. A method of making a concrete structure, which comprises:
creating a form having an outer boundary defined by at least one elongate body having an upper edge and a lower edge;
attaching an L-shaped strip adjacent to said lower edge of said elongate body, the L-shaped stripe having an inside corner radius;
pouring concrete into said form and against said inside corner radius of said L-shaped strip;
removing said form and said L-shaped strip after said concrete has partially cured to provide a concrete body having a curved edge corresponding to said L-shaped strip;
finishing said curved edge; and
allowing said concrete body to fully cure.

2. A method as recited in claim 1, wherein said inside corner radius has a ⅜ inch radius.

3. A method as recited in claim 1, also comprising the step of coating said strip with a lubricant.

4. A method as recited in claim 3, wherein said lubricant is selected from the group consisting of 3-in-1 oil, sweet oil, and form oil.

5. A method as recited in claim 1, wherein the removing step is performed by sliding said L-shaped strip longitudinally.

6. A method as recited in claim 1, wherein said form defines a patio.

7. A method as recited in claim 1, wherein said form defines a ramp.

8. A method as recited in claim 1, wherein said form defines a loading dock.

9. A method as recited in claim 1, wherein said form defines at least one step.

10. A method as recited in claim 1, wherein the attaching step includes using at least one screw to connect said L-shaped strip to said elongate body.

11. A method as recited in claim 10, wherein said at least one screw is a 1¾ inch drywall screw.

12. A method as recited in claim 10 wherein said L-shaped strip has an upper portion adjacent to said inside corner radius and said screw is connected to said upper portion of said L-shaped strip and said elongated body.

13. A method as recited in claim 10, wherein the step of removing said form and said L-shaped strip includes removing said at least one screw from said L-shaped strip.

14. A method as recited in claim 13, wherein the removing step is performed by sliding said L-shaped strip longitudinally.

15. A method as recited in claim 1, wherein said inside corner radius has a ¼″ to ½ inch radius.

16. A method as recited in claim 1, wherein said L-shape strip has an upper portion and said upper portion is 1″ long.
